(19) United States
(12) Patent Application Publication
(10) Pub. No.: US 2021/0267330 A1
(43) Pub. Date: Sep. 2, 2021

(54) CHILD CARRIER SEAT ARRANGEMENT AND METHOD FOR NAVIGATION THEREOF

(71) Applicants: Oladayo Luke, SEVERN, MD (US); OLAMIDE LUKE, SEVERN, MD (US)

(72) Inventors: Oladayo Luke, SEVERN, MD (US); OLAMIDE LUKE, SEVERN, MD (US)

(21) Appl. No.: 16/805,735

(22) Filed: Feb. 29, 2020

(51) Int. Cl. A45C 7/00; A47D 1/00; G05D 1/02

(52) U.S. Cl. CPC A45C 7/0072; A45C 7/0077; G05D 1/0231; G05D 1/0255; A47D 1/006

(57) ABSTRACT

Disclosed is a child carrier seat arrangement comprising: a child seat configured to receive a child; a carrier base detachably attached to the child seat; a wheel arrangement coupled to the carrier base, wherein the wheel arrangement provides movement to the child carrier seat arrangement; a processor coupled to the carrier base, wherein the processor is configured to: receive a first input to make the child carrier seat arrangement work in a luggage mode, wherein, in the luggage mode, a user is configured to carry the child carrier seat arrangement as hand luggage; receive a second input to make the child carrier seat arrangement work in a manual mode, wherein, in the manual mode, a user is configured to navigate the child carrier seat arrangement; receive a third input to make the child carrier seat arrangement work in an automatic mode; and a sensor module coupled to the processor, wherein the sensor module is configured to provide instructions to the processor in the automatic mode for autonomous navigation of the child carrier seat arrangement.

### TECHNICAL FIELD

The present disclosure relates generally to a mechanism for carrying of child; and more specifically, to child carrier seat arrangement. Moreover, the present disclosure also relates to methods for navigation of child carrier seat arrangement.

### BACKGROUND

Adults specifically parents carry their child to different places. However, the adults are not comfortable in carrying the child for elongated periods of time. Moreover, with regular carrying of the child, the adults often develop pain. In an example, parents often develop pain in their back due to regular carrying of the child.

To overcome this, child seats have been developed which allow the adults to carry their child by placing the child in the seat and further applying push-pull to move the child seat. However, such techniques also cause a lot of difficulties and are not desirable for carrying the child in the child seat for long durations of time.

Therefore, in the light of foregoing discussion, there exists a need to overcome the aforementioned drawbacks associated with carrying of children.

### SUMMARY

The present disclosure seeks to provide a child carrier seat arrangement. The present disclosure also seeks to provide a method for navigation of a child carrier seat arrangement. The present disclosure seeks to provide a solution to the existing problem of discomfort in carrying a child for long durations of time. An aim of the present disclosure is to provide a solution that overcomes at least partially the problems encountered in prior art, and provides techniques to enable comfortable and safe of carrying the child.

In one aspect, an embodiment of the present disclosure provides a child carrier seat arrangement comprising:
a child seat configured to receive a child;
a carrier base detachably attached to the child seat, wherein the carrier base is configured to provide support to the child seat;
a wheel arrangement coupled to the carrier base, wherein the wheel arrangement comprises a plurality of wheels to provide movement to the child carrier seat arrangement;
a processor coupled to the carrier base, wherein the processor is configured to:
   receive a first input to make the child carrier seat arrangement work in a luggage mode, wherein, in the luggage mode, a user is configured to carry the child carrier seat arrangement as hand luggage;
   receive a second input to make the child carrier seat arrangement work in a manual mode, wherein, in the manual mode, a user is configured to navigate the child carrier seat arrangement;
   receive a third input to make the child carrier seat arrangement work in an automatic mode;
a sensor module coupled to the processor, wherein the sensor module is configured to provide instructions to the processor in the automatic mode for autonomous navigation of the child carrier seat arrangement.

In another aspect, an embodiment of the present disclosure provides a method for navigation of a child carrier seat arrangement, the method comprising:
a child seat configured to receive a child;
a carrier base detachably attached to the child seat, wherein the carrier base is configured to provide support to the child seat;
a wheel arrangement coupled to the carrier base, wherein the wheel arrangement comprises a plurality of wheels to provide movement to the child carrier seat arrangement;
a processor coupled to the carrier base, wherein the processor is configured to:
   receive a first input to make the child carrier seat arrangement work in a luggage mode, wherein, in the luggage mode, a user is configured to carry the child carrier seat arrangement as hand luggage;
   receive a second input to make the child carrier seat arrangement work in a manual mode, wherein, in the manual mode, a user is configured to navigate the child carrier seat arrangement;
   receive a third input to make the child carrier seat arrangement work in an automatic mode;
a sensor module coupled to the processor, wherein the sensor module is configured to provide instructions to the processor in the automatic mode for autonomous navigation of the child carrier seat arrangement.

Embodiments of the present disclosure substantially eliminate or at least partially address the aforementioned problems in the prior art, and enables in easy carrying of the child from one position to another position for elongated periods of time.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a child carrier seat arrangement, in accordance with an embodiment of the present disclosure;

FIG. 2A is a child carrier seat arrangement in a hand luggage mode, in accordance with an embodiment of the present disclosure;

FIG. 2B is a child carrier seat arrangement in a hand luggage mode, in accordance with an embodiment of the present disclosure;

FIG. 2C is a child carrier seat arrangement in a hand luggage mode, in accordance with an embodiment of the present disclosure;

FIG. 2D is a child carrier seat arrangement in a hand luggage mode, in accordance with an embodiment of the present disclosure;

FIG. 2E is a child carrier seat arrangement in a hand luggage mode, in accordance with an embodiment of the present disclosure;

FIG. 2F is a child carrier seat arrangement in a hand luggage mode, in accordance with an embodiment of the present disclosure;

FIG. 3A is a child carrier seat arrangement in an manual mode, in accordance with an embodiment of the present disclosure;

FIG. 3B is a child carrier seat arrangement in an manual mode, in accordance with an embodiment of the present disclosure;

FIG. 3C is a child carrier seat arrangement in an manual mode, in accordance with an embodiment of the present disclosure;

FIG. 3D is a child carrier seat arrangement in an manual mode, in accordance with an embodiment of the present disclosure;

FIG. 3E is a child carrier seat arrangement in an manual mode, in accordance with an embodiment of the present disclosure;

FIG. 4A is a child carrier seat arrangement in an automatic mode, in accordance with an embodiment of the present disclosure;

FIG. 4B is a child carrier seat arrangement in an automatic mode, in accordance with an embodiment of the present disclosure;

FIG. 4C is a child carrier seat arrangement in an automatic mode, in accordance with an embodiment of the present disclosure;

FIG. 4D is a child carrier seat arrangement in an automatic mode, in accordance with an embodiment of the present disclosure;

FIG. 4E is a child carrier seat arrangement in an automatic mode, in accordance with an embodiment of the present disclosure;

FIG. 4F is a child carrier seat arrangement in an automatic mode, in accordance with an embodiment of the present disclosure;

FIG. 5A is a child carrier seat arrangement in an manual mode, in accordance with an embodiment of the manual disclosure;

FIG. 5B is a child carrier seat arrangement in an automatic mode, in accordance with an embodiment of the present disclosure; and

FIG. 6 is steps of a method for navigation of a child carrier seat arrangement, in accordance with an embodiment of the present disclosure.

In the accompanying drawings, an underlined number is employed to represent an item over which the underlined number is positioned or an item to which the underlined number is adjacent. A non-underlined iso number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a child carrier seat arrangement comprising:
a child seat configured to receive a child;
a carrier base detachably attached to the child seat, wherein the carrier base is configured to provide support to the child seat;
a wheel arrangement coupled to the carrier base, wherein the wheel arrangement comprises a plurality of wheels to provide movement to the child carrier seat arrangement;
a processor coupled to the carrier base, wherein the processor is configured to:
   receive a first input to make the child carrier seat arrangement work in a luggage mode, wherein, in the luggage mode, a user is configured to carry the child carrier seat arrangement as hand luggage;
   receive a second input to make the child carrier seat arrangement work in a manual mode, wherein, in the manual mode, a user is configured to navigate the child carrier seat arrangement;
   receive a third input to make the child carrier seat arrangement work in an automatic mode;
a sensor module coupled to the processor, wherein the sensor module is configured to provide instructions to the processor in the automatic mode for autonomous navigation of the child carrier seat arrangement.

In another aspect, an embodiment of the present disclosure provides a method for navigation of a child carrier seat arrangement, the method comprising:
a child seat configured to receive a child;
a carrier base detachably attached to the child seat, wherein the carrier base is configured to provide support to the child seat;
a wheel arrangement coupled to the carrier base, wherein the wheel arrangement comprises a plurality of wheels to provide movement to the child carrier seat arrangement;
a processor coupled to the carrier base, wherein the processor is configured to:
   receive a first input to make the child carrier seat arrangement work in a luggage mode, wherein, in the luggage mode, a user is configured to carry the child carrier seat arrangement as hand luggage;
   receive a second input to make the child carrier seat arrangement work in a manual mode, wherein, in the manual mode, a user is configured to navigate the child carrier seat arrangement;
   receive a third input to make the child carrier seat arrangement work in an automatic mode;
a sensor module coupled to the processor, wherein the sensor module is configured to provide instructions to the processor in the automatic mode for autonomous navigation of the child carrier seat arrangement.

The present disclosure provides techniques to enable adults especially parents to carry their child from one position to another position for long periods of time without causing any pain to the adult.

The present disclosure provides the child carrier seat arrangement. Throughout the present disclosure the term “child carrier seat arrangement” refers to a combination of hardware and software components and one or more moving components which are configured to enables carrying of a child on a child seat. Generally, the child is accompanied by an adult person such as a parent of the child who intends to carry the child from one position to another position. The child carrier seat arrangement enables the adult person to place the child on the seat and carry the child by moving the child carrier seat arrangement. The child carrier seat arrangement provides two modes of working wherein in one mode the adult has to manually move the child carrier seat arrangement and in another mode the child carrier seat arrangement automatically moves. The adult person may choose any one of the two modes based on requirement.

The child carrier seat arrangement comprises the child seat configured to receive the child. Throughout the present disclosure the term “child seat” refers to a space for accommodating a child. Optionally, the child seat has a size marginally bigger than a size of the child. Optionally, the child seat is designed in a way to protect the child from any injuries while being carried by an adult. Optionally, the child carrier seat arrangement is configured to have a child seat of varying size and shape. Optionally, the present disclosure allows a user to employ an already existing child seat with the user with the child carrier seat arrangement. In an embodiment, the child carrier seat arrangement may not initially comprise the child seat and thereby may receive a child seat which is already been employed by the user.

The child carrier seat arrangement comprises the carrier base detachably attached to the child seat, wherein the carrier base is configured to provide support to the child seat. In other words, the carrier base is a basic structure/framework of the child carrier seat arrangement which provides support to the child seat. The child seat is attached to the carrier base in a way that a given user or the adult may detach the child seat from the child carrier seat arrangement based on requirement and desirability of the user. Optionally, the carrier base is made of a material which enables in holding a weight of the child seat and the child.

In an embodiment, the carrier base comprises at least one belt and one or more hooks wherein the at least one belt when attached to the one or more hooks provide stability to the child in the child seat. Optionally, the at least one belt and one or more hooks enables in holding the child in the child carrier seat arrangement and not allowing the child to accidently come out of the child carrier seat arrangement. Moreover, the at least one belt and one or more hooks provide safety to the child. Optionally, the one or more hooks may be present on both the horizontal sides of the carrier base. Optionally, the one or more hooks may be present on both the vertical sides of the carrier base. More optionally, the one or more hooks may be present on both the horizontal sides and both the vertical sides of the carrier base.

The child carrier seat arrangement comprises the wheel arrangement coupled to the carrier base, wherein the wheel arrangement comprises a plurality of wheels to provide movement to the child carrier seat arrangement. Throughout the present disclosure the term “wheel arrangement” refers to a combination of the plurality of wheels which together enables in moving the child carrier seat arrangement in a specific direction. In an example, the wheel arrangement comprises 2 front wheels and 2 back wheels. In such an example, a movement of all wheels in anti-clock wise direction enables the carrier seat arrangement to move forward, a movement of all wheels in clock wise direction enables the carrier seat arrangement to move backward, a movement of front left wheel and back left wheel and no movement of front right wheel and back right wheel enables the carrier seat arrangement to move leftward, and a movement of front right wheel and back right wheel and no movement of front left wheel and back left wheel enables the carrier seat arrangement to move rightward.

In an embodiment, the wheel arrangement comprises four free wheels. Optionally, the four free wheels may be arranged in different configurations. In an example, two wheels of the four wheels may be at a frontend of child carrier seat arrangement and two wheels may be at the backend of the child carrier seat arrangement. In another example, one wheel may be at a frontend, one wheel at a backend and two wheels at the center of the child carrier seat arrangement. In another example, one wheel may be at a frontend, and three wheels at a backend of the child carrier seat arrangement.

The child carrier seat arrangement comprises processor coupled to the carrier base. Throughout the present disclosure, the term “processor” refers to a computational element that is operable to respond to and processes instructions that drive the child carrier seat arrangement. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices and various elements associated with a processing device that may be shared by other processing devices. Additionally, the one or more individual processors, processing devices and elements are arranged in various architectures for responding to and processing the instructions that drive the child carrier seat arrangement.

The processor is configured to receive a first input to make the child carrier seat arrangement work in the luggage mode, wherein, in the luggage mode, the user is configured to carry the child carrier seat arrangement either with the handle or with back pack accessories or belt and with all wheels folded in, pcb in standby or shut down and motor wheel cover on. Throughout the present disclosure, the term “first input” refers to an instruction received from the user or the adult to switch on the luggage mode of the child carrier seat arrangement. Optionally, the child carrier seat arrangement comprises one or more buttons to receive the second input from the user. In an example, the child carrier seat arrangement comprises a toggle switch to enable the user to provide the first input. Optionally, the processor is communicatively coupled to a user device, remote control, and wrist watch having a software application for providing the second input to the processor.

The processor is configured to receive a second input to make the child carrier seat arrangement work in the manual mode, wherein, in the manual mode, the user is configured to navigate the child carrier seat arrangement. Throughout the present disclosure, the term “second input” refers to an instruction received from the user or the adult to switch on the manual mode of the child carrier seat arrangement. Optionally, the child carrier seat arrangement comprises one or more buttons to receive the second input from the user. In an example, the child carrier seat arrangement comprises a toggle switch to enable the user to provide the second input. Optionally, the processor is communicatively coupled to a user device, remote control, and wrist watch having a software application for providing the second input to the processor. In an example, the user device may be a mobile phone, a tablet, a phablet and other portable communication devices. Throughout the present disclosure, the term “manual mode” refers to a mode of operation of the child carrier seat arrangement wherein the user manually moves the child carrier seat arrangement from one position to another position.

In an embodiment, the processor is configured to provide a handle to navigate the child carrier seat arrangement in the manual mode by the user. Optionally, the handle enables the user to move the child carrier seat arrangement. In an example, the user may provide a push to the handle and make the child carrier seat arrangement move in a forward direction. In another example, the user may provide a push to the handle and make the child carrier seat arrangement move in a backward direction. Optionally, the handle is a steering wheel which enables the user to control the movement of the child carrier seat arrangement. Optionally, the push or pull received by the handle enables in movement of the one or more wheels of the wheel arrangement.

The processor is configured to receive a third input to make the child carrier seat arrangement work in an automatic mode. Throughout the present disclosure, the term “third input” refers to an instruction received from the user or the adult to switch on the automatic mode of the child carrier seat arrangement. Optionally, the child carrier seat arrangement comprises one or more buttons to receive the third input from the user. In an example, the child carrier seat arrangement comprises a toggle switch to enable the user to provide the third input. Optionally, the processor is communicatively coupled to a user device having a software application for providing the second input to the processor. Throughout the present disclosure, the term “automatic mode” refers to a mode of operation of the child carrier seat arrangement wherein the child carrier seat arrangement automatically moves in the direction intended for movement by the user for moving from one position to another position. Optionally, the child carrier seat arrangement may follow the movement of the user or the adult associated with the child carrier seat arrangement. Optionally, the child carrier seat arrangement moves based on a location of destination provided by the user.

The child carrier seat arrangement comprises the sensor module coupled to the processor, wherein the sensor module is configured to provide instructions to the processor in the automatic mode for autonomous navigation of the child carrier seat arrangement. Throughout the present disclosure, the term “sensor module” refers to a circuitry which enables in providing instructions for avoiding obstacles and moving in safe path for reaching the location of destination of the child carrier seat arrangement. Optionally, the child carrier seat arrangement comprises a Global Positioning System (GPS) module coupled to the sensor module. The GPS module provides the direction for movement based on the location of destination of the child carrier seat arrangement.

In an embodiment, the sensor module comprises at least one ultrasonic sensor and a camera. Optionally, the ultrasonic sensor and the camera enable in providing signals to the processor to know about one or more obstacles in the path of the child carrier seat arrangement. In an example, the ultrasonic sensor and the camera enable in providing signals about shape and size of the obstacle, type of obstacles, speed of obstacle and the like. Optionally, the ultrasonic sensor and the camera enable in providing signals to the processor about safe paths for movement of the child carrier seat arrangement. Optionally, the ultrasonic sensor and the camera are mounted in a frontend of the carrier seat arrangement. Optionally, the ultrasonic sensor and the camera are mounted in a frontend and sides of the carrier seat arrangement.

In an embodiment, the processor in the automatic mode is configured to employ machine learning based modules. Throughout the present disclosure, the term “machine learning based modules” as used herein refers to any mechanism or computationally intelligent system that combines knowledge, techniques, and methodologies for controlling the child carrier seat arrangement. Furthermore, the machine learning based modules is configured to apply knowledge and that can adapt it-self and learn to do better in changing environments. Additionally, employing any computationally intelligent technique, the machine learning based modules is operable to adapt to unknown or changing environment for better performance. The machine learning based modules includes fuzzy logic engines, decision-making engines, preset targeting accuracy levels, and/or programmatically intelligent software. Beneficially, the machine learning based modules enables in accurate navigation of the child carrier seat arrangement.

In an embodiment, the child carrier seat arrangement further comprises one or more motors coupled to the wheel arrangement which provide movement of the child carrier seat arrangement in the automatic mode. Optionally, the one or more motors are powered by a direct current (DC) battery. The one or more motors provide a rotational movement to the one or more wheels of the wheel arrangement. Optionally, the speed of movement and further the speed of rotation of the one or more wheels are controlled by varying the speed of rotation of the one or more motors. In an embodiment, the wheel arrangement comprises four free wheels and one or more motor wheels, wherein the one or more motor wheels are coupled to the one or more motors. Optionally, in the automatic mode, the one or more motor wheels receive rotational power from the one or more motors and enable movement of the child carrier seat arrangement. Optionally, a motor is used to provide a lift mechanism to the one or more motor wheels wherein in the automatic mode, the lift mechanism enables the one or more motor wheels to come in an open position for being used and in the manual mode, the lift mechanism enables the one or more motor wheels to come in an close position.

Optionally, the wheel arrangement comprises four free wheels and one or more motor wheels for manual mode. Optionally, in the manual mode, the one or more motor wheels enables in providing an additional force to the user, in the direction of movement of the child carrier seat arrangement. Optionally, the force applied via handle by user is less than the force provided by the one or more motor wheels and thereby the user merely provides a direction of movement of the child carrier seat arrangement via the handle.

The present disclosure also relates to the method as described above. Various embodiments and variants disclosed above apply mutatis mutandis to the method.

Optionally, in the method, the sensor module comprises at least one ultrasonic sensor and a camera.

Optionally, in the method, the processor is configured to provide a handle to navigate the child carrier seat arrangement in the manual mode by a user.

Optionally, in the method, the carrier base comprises at least one belt and one or more hooks wherein the at least one belt when attached to the one or more hooks provide stability to the child in the child seat.

Optionally, in the method, the child carrier seat arrangement further comprises one or more motors coupled to the wheel arrangement which provide movement of the child carrier seat arrangement in the automatic mode.

Optionally, in the method, the wheel arrangement comprises four free wheels.

Optionally, in the method, the wheel arrangement comprises four free wheels and two motor wheels, wherein the two motor wheels are coupled to the one or more motors.

### DETAILED DESCRIPTION OF THE DRAWINGS

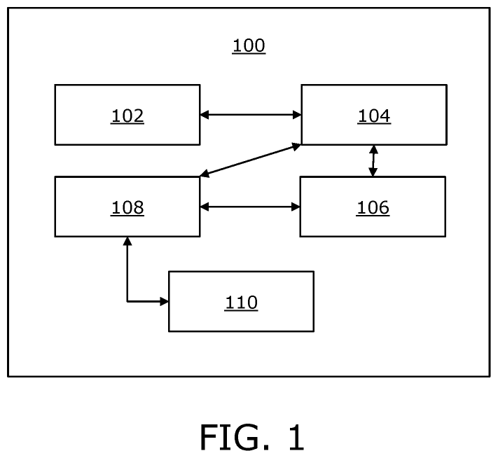

Referring to FIG. 1, illustrated is a block diagram of a child carrier seat arrangement 100, in accordance with an embodiment of the present disclosure. The child carrier seat arrangement comprises a child seat 102, a carrier base 104, a wheel arrangement 106, a processor 108 and a sensor module 110. The carrier base 104 is detachably attached to the child seat 102. The wheel arrangement 106 is coupled to the carrier base 104. The processor 108 is coupled to the carrier base 104 and the sensor module 110.

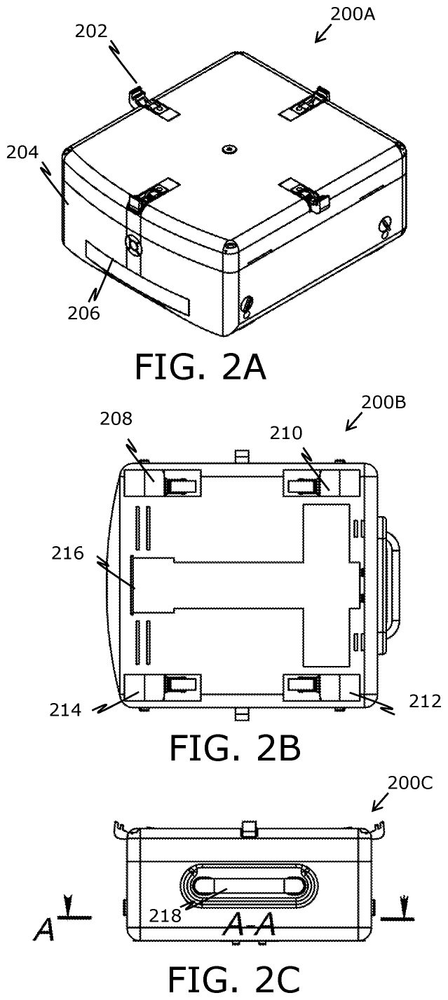

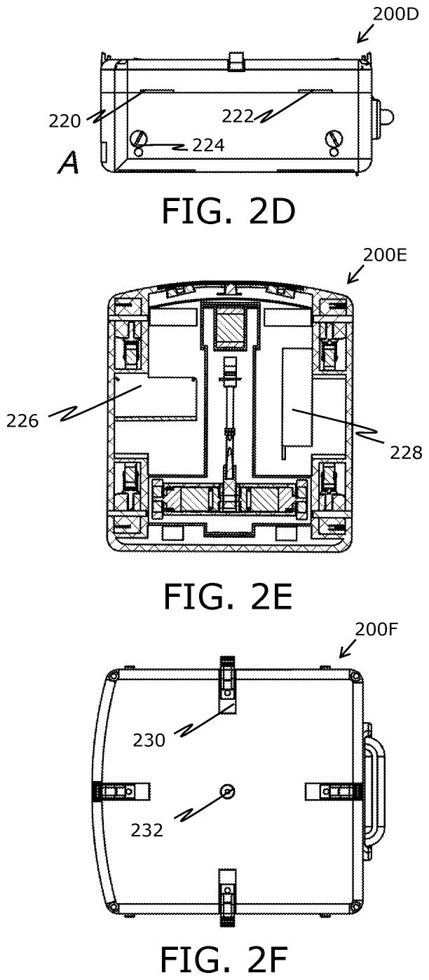

Referring to FIG. 2A, illustrated is a child carrier seat arrangement 200A in a hand luggage mode, in accordance with an embodiment of the present disclosure. As shown, the child carrier seat arrangement 200A comprises a carrier gripper 202, a body 204, and camera and sensor cover 206.

Referring to FIG. 2B, illustrated is a child carrier seat arrangement 200B in a hand luggage mode, in accordance with an embodiment of the present disclosure. As shown, the child carrier seat arrangement comprises a left front wheel twist adjuster 208, left rear wheel twist adjuster 210, right rear wheel twist adjuster 212, and right front wheel twist adjuster 214.

Referring to FIG. 2C, illustrated is a child carrier seat arrangement 200C in a hand luggage mode, in accordance with an embodiment of the present disclosure. As shown, the child carrier seat arrangement 200C comprises a handle.

Referring to FIG. 2D, illustrated is a child carrier seat arrangement 200D in a hand luggage mode, in accordance with an embodiment of the present disclosure. As shown, the child carrier seat arrangement 200D comprises a child seat mounting belt hole 220, a child seat mounting belt hole 222, and wheel twist mechanism lock 224.

Referring to FIG. 2E, illustrated is a child carrier seat arrangement 200E in a hand luggage mode, in accordance with an embodiment of the present disclosure. As shown, the child carrier seat arrangement 200E comprises a pcb 226, and a battery 228.

Referring to FIG. 2F, illustrated is a child carrier seat arrangement 200F in a hand luggage mode, in accordance with an embodiment of the present disclosure. As shown, the child carrier seat arrangement 200F comprises a claw/gripper housing 230, and coil pulley mechanism 232.

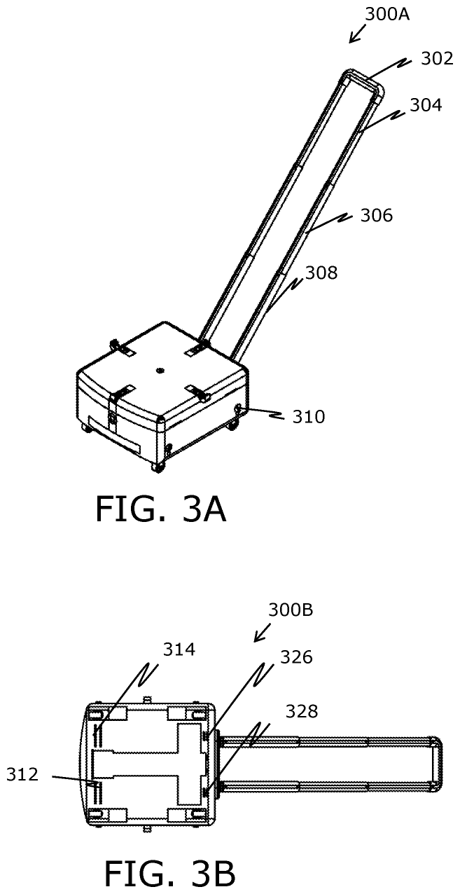

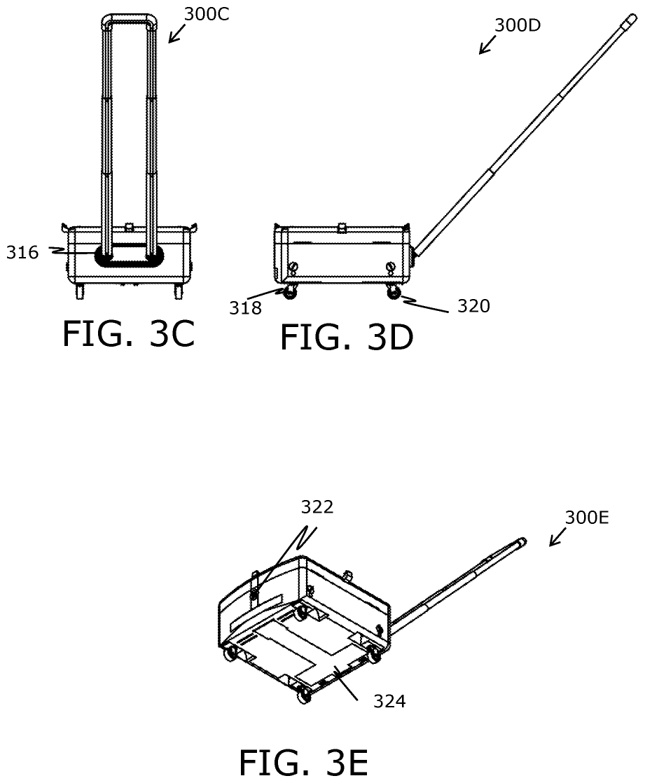

Referring to FIG. 3A, illustrated is a child carrier seat arrangement 300A in a manual mode, in accordance with an embodiment of the present disclosure. As shown, the child carrier seat arrangement 300A comprises a child carrier trolley handle 230, trolley handle level 1 304, trolley handle level 2 306, trolley handle level 3 308 and a unlocked wheel twist lock 310.

Referring to FIG. 3B, illustrated is a child carrier seat arrangement 300B in a manual mode, in accordance with an embodiment of the present disclosure. As shown, the child carrier seat arrangement 300B comprises a bottom front left back pack belt hole 314, a bottom from right back pack belt hole 312, a bottom rear right back pack belt hole and a bottom rear left back pack belt hole 326.

Referring to FIG. 3C, illustrated is a child carrier seat arrangement 300C in a manual mode, in accordance with an embodiment of the present disclosure. As shown, the child carrier seat arrangement 300C comprises a trolley handle mechanism base 316.

Referring to FIG. 3D, illustrated is a child carrier seat arrangement 300D in a manual mode, in accordance with an embodiment of the present disclosure. As shown, the child carrier seat arrangement 300D comprises a front left free wheel 318, and a front right free wheel 320.

Referring to FIG. 3E, illustrated is a child carrier seat arrangement 300E in a manual mode, in accordance with an embodiment of the present disclosure. As shown, the child carrier seat arrangement 300E comprises a control buttons 322, and a bottom motor wheel mechanism cover 324.

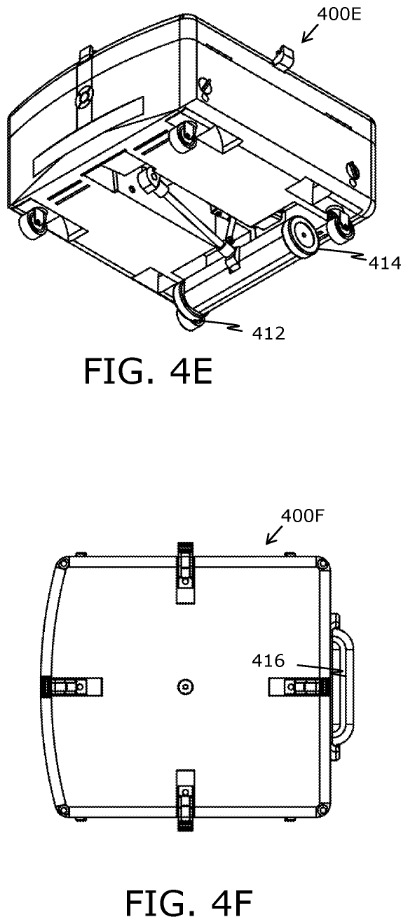

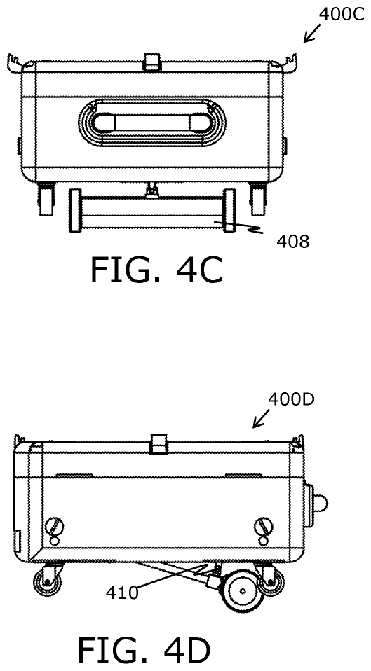

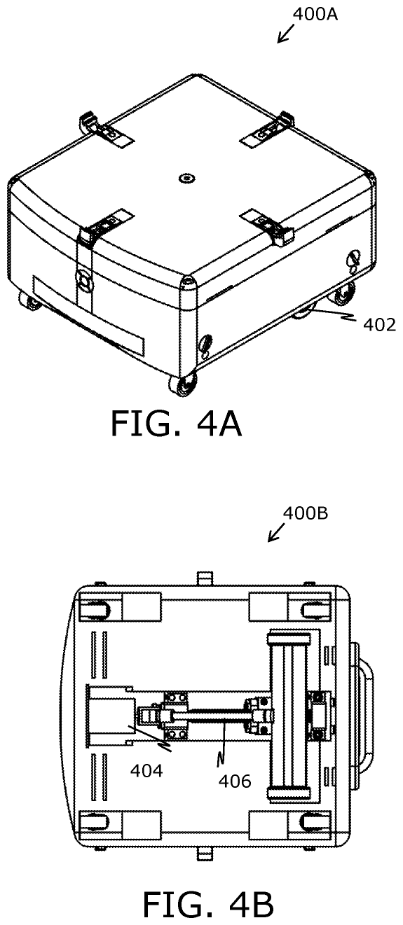

Referring to FIG. 4A, illustrated is a child carrier seat arrangement 400A in an automatic mode, in accordance with an embodiment of the present disclosure. As shown, the child carrier seat arrangement 400A sis comprises a left motor wheel 402.

Referring to FIG. 4B, illustrated is a child carrier seat arrangement 400B in an automatic mode, in accordance with an embodiment of the present disclosure. As shown, the child carrier seat arrangement 400B comprises a left motor 404, and a lift mechanism connector tube 406.

Referring to FIG. 4C, illustrated is a child carrier seat arrangement 400C in an automatic mode, in accordance with an embodiment of the present disclosure. As shown, the child carrier seat arrangement 400C comprises a motor wheel case 408.

Referring to FIG. 4D, illustrated is a child carrier seat arrangement 400D in an automatic mode, in accordance with an embodiment of the present disclosure. As shown, the child carrier seat arrangement 400D comprises a lift mechanism connector upper tube 410.

Referring to FIG. 4E, illustrated is a child carrier seat arrangement 400E in an automatic mode, in accordance with an embodiment of the present disclosure. As shown, the child carrier seat arrangement 400E comprises a rear right motor wheel 412, and a rear left motor wheel 414.

Referring to FIG. 4F, illustrated is a child carrier seat arrangement 400F in an automatic mode, in accordance with an embodiment of the present disclosure. As shown, the child carrier seat arrangement 400F comprises a folded trolley handle 416.

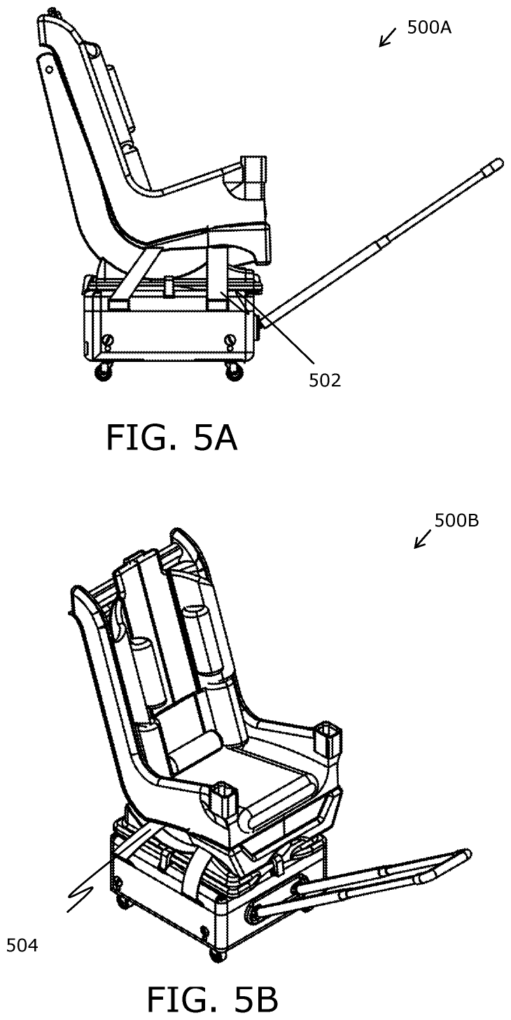

Referring to FIG. 5A, illustrated is a child carrier seat arrangement 400A in an manual mode, in accordance with an embodiment of the present disclosure. As shown, the child carrier seat arrangement 400A comprises a front holding belt 502.

Referring to FIG. 5B, illustrated is a child carrier seat arrangement 400A in an automatic mode, in accordance with an embodiment of the present disclosure. As shown, the child carrier seat arrangement 400A comprises a rear holding belt 504.

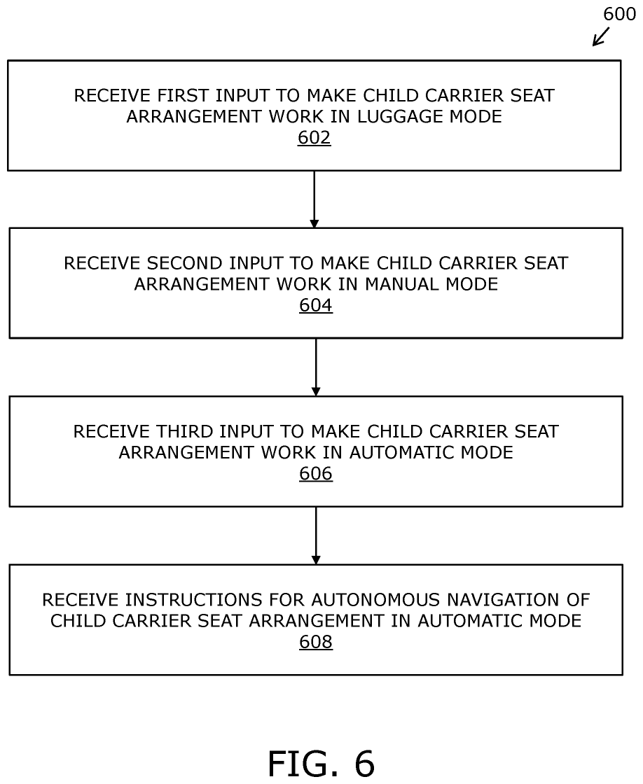

Referring to FIG. 6, illustrated is steps of a method 600 for navigation of a child carrier seat arrangement, in accordance with an embodiment of the present disclosure. The method comprises a child seat configured to receive a child, a carrier base configured to provide support to the child seat, a wheel arrangement configured to provide movement to the child carrier seat arrangement, and a processor coupled to the carrier base. At a step 602, a second input is received to make the child carrier seat arrangement work in a manual mode. Moreover, in the manual mode, a user is configured to navigate the child carrier seat arrangement. At a step 604, a third input is received to make the child carrier seat arrangement work in an automatic mode. At a step 606, instructions are received to enable the automatic mode for autonomous navigation of the child carrier seat arrangement.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A child carrier seat arrangement comprising:
a child seat configured to receive a child;
a carrier base detachably attached to the child seat, wherein the carrier base is configured to provide support to the child seat;
a wheel arrangement coupled to the carrier base, wherein the wheel arrangement comprises a plurality of wheels to provide movement to the child carrier seat arrangement;
a processor coupled to the carrier base, wherein the processor is configured to:
receive a first input to make the child carrier seat arrangement work in a luggage mode, wherein, in the luggage mode, a user is configured to carry the child carrier seat arrangement as hand luggage;
receive a second input to make the child carrier seat arrangement work in a manual mode, wherein, in the manual mode, a user is configured to navigate the child carrier seat arrangement;
receive a third input to make the child carrier seat arrangement work in an automatic mode;
a sensor module coupled to the processor, wherein the sensor module is configured to provide instructions to the processor in the automatic mode for autonomous navigation of the child carrier seat arrangement.

2. A child carrier seat arrangement of claim 1, wherein the sensor module comprises at least one ultrasonic sensor and a camera.

3. A child carrier seat arrangement of claim 1, wherein the processor is configured to provide a handle to navigate the child carrier seat arrangement in the manual mode by a user.

4. A child carrier seat arrangement of claim 1, wherein the carrier base comprises at least one belt and one or more hooks wherein the at least one belt when attached to the one or more hooks provide stability to the child in the child seat.

5. A child carrier seat arrangement of claim 1, wherein the child carrier seat arrangement further comprises one or more motors coupled to the wheel arrangement which provide movement of the child carrier seat arrangement in the automatic mode.

6. A child carrier seat arrangement of claim 1, wherein the wheel arrangement comprises four free wheels.

7. A child carrier seat arrangement of claim 5, wherein the wheel arrangement comprises two free wheels and two motor wheels, wherein the two motor wheels are coupled to the one or more motors.

8. A child carrier seat arrangement of claim 1, wherein in the automatic mode the processor is configured to employ machine learning based modules.

9. A method for navigation of a child carrier seat arrangement, the method comprising:
a child seat configured to receive a child;
a carrier base detachably attached to the child seat, wherein the carrier base is configured to provide support to the child seat;
a wheel arrangement coupled to the carrier base, wherein the wheel arrangement comprises a plurality of wheels to provide movement to the child carrier seat arrangement;
a processor coupled to the carrier base, wherein the processor is configured to:
receive a first input to make the child carrier seat arrangement work in a hand luggage mode, wherein, in the hand luggage mode, a user is configured to carry the child carrier seat arrangement as hand luggage;
receive a second input to make the child carrier seat arrangement work in a manual mode, wherein, in the manual mode, a user is configured to navigate the child carrier seat arrangement;
receive a third input to make the child carrier seat arrangement work in an automatic mode;
a sensor module coupled to the processor, wherein the sensor module is configured to provide instructions to the processor in the automatic mode for autonomous navigation of the child carrier seat arrangement.

10. A method of claim 9, wherein the sensor module comprises at least one ultrasonic sensor and a camera.

11. A method of claim 9, wherein the processor is configured to provide a handle to navigate the child carrier seat arrangement in the manual mode by a user.

12. A method of claim 9, wherein the carrier base comprises at least one belt and one or more hooks wherein the at least one belt when attached to the one or more hooks provide stability to the child in the child seat.

13. A method of claim 9, wherein the child carrier seat arrangement further comprises one or more motors coupled to the wheel arrangement which provide movement of the child carrier seat arrangement in the automatic mode.

14. A method of claim 9, wherein the wheel arrangement comprises four free wheels.

15. A method of claim 13, wherein the wheel arrangement comprises two free wheels and two motor wheels, wherein the two motor wheels are coupled to the one or more motors.
